(19) United States
(12) Patent Application Publication
(10) Pub. No.: US 2002/0105666 A1
(43) Pub. Date: Aug. 8, 2002

(54) Method and system for secured printing of documents using biometric identification

(76) Inventor: Robert Sesek, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/776,057

(22) Filed: Feb. 2, 2001

(51) Int. Cl. G06F 15/00; B41F 1/00

(52) U.S. Cl. 358/1.14

(57) ABSTRACT

Bio signatures (e.g., fingerprints, retinal patterns and voice patterns) are associated with a secured print job being sent from a host computer to a printer. The printer has a biometric identification device connected thereto or integrated therein. The printer will not print the secured print job until a bio signature matching the bio signature in the print job is input using the biometric identification device at the printer. In this way, the print job is only output when its owner or a designated recipient is at the printer and ready to secure the hardcopy.

### FIELD OF THE INVENTION

The present invention relates to the field of printing hardcopies of electronic documents. More particularly, the present invention is a method and system of associating one or more bio signatures with a print job such that a matching bio signature must be input to an image printing device before the print job will be output in hardcopy form.

### BACKGROUND OF THE INVENTION

With modern computers and printers, a tremendous amount and variety of information can be managed, formatted and printed. Electronic documents containing text, numbers, graphics, photographs and other elements can be created using a variety of applications running on a host computer. Such applications include word processing, desk-top publishing, accounting, computer-aided-design (CAD) and other applications. After an electronic document is created, it can be submitted to a printer or other image printing device for rendering in hardcopy form.

Because a printer is only occasionally required to print an electronic document that a user has received or created, a common practice in many office environments is for a number of users to share a single printer. Additionally, a number of users may share a printer which serves a special, particular purpose such as a large format, color or special finish printer. The printer is usually connected to the computers of the various users through a network, such as a Local Area Network (LAN). Consequently, any of the various users connected to that printer can submit print jobs to that printer for hardcopy output.

While such networking and resource sharing maximizes the use of the printer and minimizes the number of printers needed to support the networked users, there are also disadvantages. A particular disadvantage, on which the present invention is focused, is the difficulties in producing and controlling confidential documents using a shared printer to which a number of people have access. A related problem is that of sending a confidential facsimile transmission.

In a typical scenario, a networked printer or a fax machine is shared by a number of users is located in a common area where it is equally accessible to all of its designated users. This common area is typically outside and some distance from the office or workspace of any one of the designated users.

Consequently, when a user sends a print job to the printer, that user may not know whether another user is also using the printer at that time. The user will also probably not know whom, if anyone, is near the printer and may be watching its output when a print job is sent. In fact, if print jobs are dynamically allocated to printers on the network based on present print queues, the user may not be able to control or predict which printer on the network will receive the print job.

Similarly, when a confidential fax is sent, the sender has little means of ensuring that only the intended recipient will see the facsimile.

This poses a distinct problem if the document being printed is confidential. If the document is, for example, a confidential financial record, a sensitive personnel evaluation or some other document to which the owner needs to restrict access, it may be difficult to produce a needed hardcopy of the document with a shared printer resource or securely send the document via facsimile.

For printing, the user will have to send the print job to the printer and then hurry to the printer to secure the document, hoping that in the interim the document has not been observed or taken by an unauthorized person. If the user is interrupted in his or her trip to the printer, for example, by a phone call, the confidential document may remain accessible for some time. For faxing, the sender must ask the recipient to be at the receiving fax machine as the fax is transmitted.

In some networks, particularly larger networks, sending print jobs to a particular printer may be a means of transmitting a document between parties. For example, if the creator of the document needs to deliver a copy to a recipient, the creator of the document can send the document as a print job to a particular printer on the network that is physically located convenient to the recipient. The printer then prints the document. The sender notifies the recipient, and the recipient can retrieve the printed document.

While this scenario may be an easy means of transmitting a printed document to a recipient, if the document is confidential, all the concerns and problems discussed above are again raised. The sender will probably have no idea who may be located at the target printer and will have access to the document when the print job is sent. If the recipient is slow in retrieving the document, it will likely be accessible to unauthorized people in the interim. Additionally, if the printer (or fax machine) has many jobs to print in the queue or experiences a problem, such as a paper jam, the recipient will be forced to wait while all pending jobs are printed or address the printer error so as not to compromise the confidentiality of the print job. This is very similar to the problems inherent in sending a secure facsimile.

Consequently, there is a need in the art for a method and system of securing print jobs such that the print jobs are only executed by the printer for an authorized person who is present at and operating the printer.

### SUMMARY OF THE INVENTION

The present invention meets the above-described needs and others. Specifically, the present invention is a method and system of securing print jobs such that print jobs are only executed by the printer for an authorized person who is present at and operating the printer. As used herein the term “printer” will be used to refer generically to all image printing devices that output a hardcopy product. Thus, “printer” includes, but is not limited to, laser printers, inkjet printers, dot-matrix printers, multi-function peripherals (“MFPs”), plotters, digital copiers, photocopiers, etc. One or more persons may be authorized to release a secure print job under the principles of the present invention. Additional advantages and novel features of the invention will be set forth in the description which follows or may be learned by those skilled in the art through reading these materials or practicing the invention.

The present invention may be embodied and described as a system for printing a secured print job that has one or more bio signatures associated therewith. The system preferably includes a printer for outputting print jobs in hardcopy form, and a biometric identification device associated with the printer for inputting bio signatures to the printer. The printer will not print the secured print job unless a bio signature is entered with the biometric identification device that matches a bio signature associated with the secured print job.

The printer may also include a display device for listing pending secured print jobs, and a user input device for selecting a secured print job to output. The printer may be a fax machine. A preferred bio signature is an electronic representation of a user's fingerprint generated with a fingerprint scanner.

In one preferred embodiment, a host computer is used for generating the secured print job by associating one or more bio signatures with the print job and transmitting the print job to the printer. A second biometric identification device may be associated with the host computer for generating the bio signature that is then associated with the secured print job.

The host computer and the printer may be connected via a computer network. In this case; the one or more bio signatures associated with the secured print job may be retrieved by the host computer from the computer network.

The printer may also deny access to configuration controls of the printer unless an authorized bio signature matching a bio signature stored in the computer is input using the biometric identification device. The printer may also track usage of the printer using bio signatures input with the biometric identification device.

The present invention also encompasses the methods of making and operating the system described above. Specifically, the present invention encompasses a method of printing a secured print job that has one or more bio signatures associated therewith by printing the secured print job only when a bio signature is entered into the printer with a biometric identification device associated with the printer that matches the a bio signature associated with the secured print job.

The present invention also encompasses the computer-readable instructions necessary to cause the printer and/or host computer to operate in the manner described above. Specifically, the present invention encompasses computer-readable instructions stored on a medium for storing computer readable instructions, the instructions causing a printer to print a secured print job only when a bio signature is entered into the printer with a biometric identification device associated with the printer that matches the a bio signature associated with the secured print job.

### BRIEF DESCRIPTION OF THE DRAWINGS

The accompanying drawings illustrate the present invention and are a part of the specification. Together with the following description, the drawings demonstrate and explain the principles of the present invention.

FIG. 1 is a diagram of a system according to a preferred embodiment of the present invention.

FIG. 2 is a diagram of the system of FIG. 1 incorporated into a computer network according to the principles of the present invention.

FIG. 3 is a flowchart illustrating a preferred method of printing a secured printed job according to the present invention.

FIG. 4 is a flowchart continuing the method illustrated in FIG. 3.

FIG. 5 is a flowchart of a preferred method of controlling the access to the configuration controls of a printing device according to the principles of the present invention.

### DETAILED DESCRIPTION OF THE PREFERRED EMBODIMENTS

The present invention provides a method and system for the secure printing of print jobs, particularly with a shared printer resource. According to the preferred embodiment of the present invention, a bio signature is associated with, or embedded in, a confidential print job. The print job is then sent to a printer which will require the input of a matching bio signature before outputting the print job in hardcopy form.

As used herein the term “printer” will be used to refer generically to all printing devices that output a hardcopy product. Thus, “printer” includes, but is not limited to, laser printers, inkjet printers, dot-matrix printers, multi-function peripherals (“MFPs”), plotters, digital copiers, photocopiers, facsimile machines, etc. A multi-function peripheral is a device that combines the functionality of two or more devices. For example, an MFP may provide the functionality of a printer, a scanner, a photocopier and a facsimile machine.

The term “print media” will be used to refer generally to all media that might be printed on by a printer. For example, “print media” means, but is not limited to, paper, cardstock, transparencies, envelopes, labels, films, etc.

The term “bio signature” is used to refer to an electronic data structure that represents and is derived from a part or characteristic of a user's person that is unique to that user. A bio signature is created by scanning or sensing with an electronic system a unique aspect of a user's person. A bio signature may be, but is not limited to, a an electronic representation of a user's fingerprint, a user's voice, a user's retinal pattern, genetic composition or any other biometric measurement, etc.

The term “biometric identification device” is used to refer generally to a device which generates a bio signature, i.e., scans or senses a unique aspect of a user's person to output a bio signature so that the bio signature can be compared by a computerized system against a stored bio signature to verify the identity of the person inputting the bio signature to the biometric identification device. Examples of biometric identification devices include, but are not limited to, fingerprint scanners, retinal scanners and voiceprint systems (i.e., a microphone and associated voice processing hardware or software).

The term “secured print job” will mean a print job having a bio signature incorporated therein or associated therewith. A secured print job may be an electronic document faxed to a fax machine or MFP with faxing capabilities. A secured print job is output by a printer of the present invention only when a bio signature matching that transmitted with the secured print job is entered using a biometric identification device associated with the printer.

One possible solution to the problem of outputting a hardcopy of a confidential document on a shared printer resource that does not utilize a bio signature is to associate a Personal Identification Number (“PIN”) with the print job. The user would then be required to enter the PIN at the printer, using a user interface of the printer, in order to have the printer output the print job.

However, this approach is less secure and convenient than using a bio signature. For example, the user must remember his or her PIN and enter it at the printer to output a secured print job. If the user is observed entering the PIN, the observer may gain unauthorized access to future secured print jobs.

Moreover, if the user wishes to have a recipient print and receive the secured print job, the user must give that recipient the PIN. The recipient may then use the PIN without authorization or carelessly divulge the PIN to another. The PIN may also be intercepted by an unauthorized person as it is communicated to the intended recipient. Consequently, the use of a bio signature is the preferred means of implementing the present invention.

A preferred embodiment of the present invention uses fingerprints as the form of bio signature that identifies a user. An explanation of this embodiment, using the drawings, will follow. However, those skilled in the art will understand that the described systems and methods may be modified to utilize other forms of bio signature under the principles of the present invention.

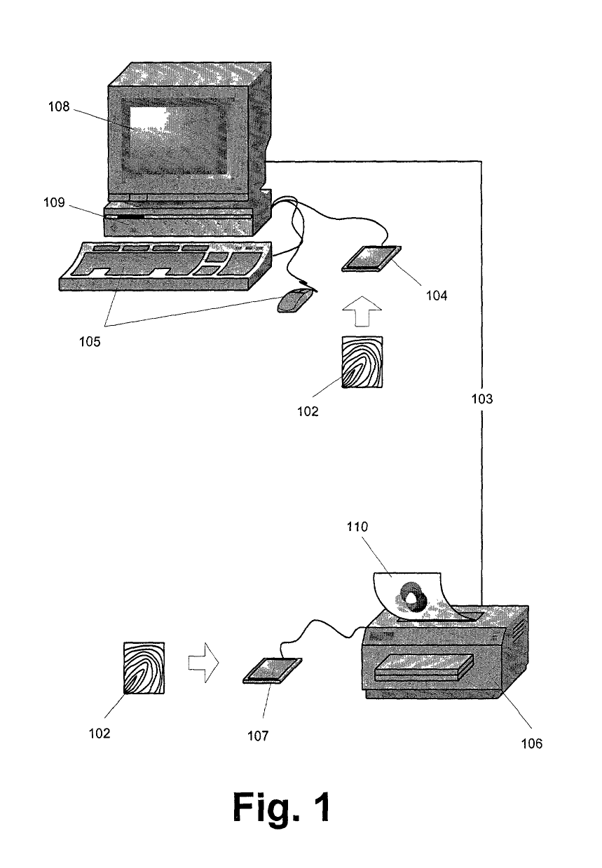

FIG. 1 illustrates a preferred embodiment of the present invention. As shown in FIG. 1, a system of the present invention may include a host computer (109) with a monitor (108) and user interface (105). The user interface (105) typically includes a keyboard and mouse. With the host computer (109), the user can generate or receive electronic documents.

These documents can be printed (i.e., rendered in hardcopy form) by a printer (106) connected to the host computer (109). The connection (103) between the host computer (109) and the printer (106) may be any connection capable of carrying print job data from the host computer (109) to the printer (106). The printer (106) is likely a shared resource located away from the host computer (109), but need not be so. The printer (106) may be located in the same room or office as the host computer (109). If the printer (106) is located with the host computer (109), the connection (103) may be a direct serial or parallel connection. If the printer (106) is located away from the host computer (109), the connection (103) is more likely an Ethernet, LAN, WAN, phone line or other network connection.

If the user wishes to send a secured print job to the printer (106), the host computer (109) may have a biometric identification device (104) connected thereto or integrated therewith. This biometric identification device (104) can be used to input a bio signature from the user. The user can then embed this bio signature in the secured print job being sent to the printer (106). The host computer (109) may store the user's bio signature for repeated association with secured print jobs. Alliteratively, the system may require the user to input a fresh bio signature using the biometric identification device (104) each time a secured print job is generated.

The host computer (109) may also be replaced by a fax machine that is sending a secured fax to a printer (106) which is a fax machine or an MFP.

In the exemplary embodiment of FIG. 1, the bio signature used is an electronic representation of a fingerprint (102), and the biometric identification device (104) is a fingerprint scanner. However, as will be appreciated by those skilled in the art, other biometric identification devices sensitive to other biometric signatures, such as a retinal scanner or voiceprint analyzer, may be used in place of the fingerprint scanner (104) illustrated in FIG. 1.

The bio signature is then incorporated into the secured print job by the host computer (109) and transmitted to the printer (106) via the connection (103). Before the printer (106) will print the secured print job, i.e., output the print job in hardcopy form, the printer user must input a bio signature matching that incorporated in the secured print job. Consequently, a biometric identification device (107) is connected to, or integrated into, the printer (106).

When the document recipient inputs a bio signature (102) using the biometric identification device (107), the input bio signature is compared to the bio signature in the secured print job. A hardcopy of the print job (110) is only output by the printer when a bio signature matching the bio signature of the print job is input using the biometric identification device (107). Again, the biometric identification device (107) associated with the printer (106) in the illustrated example is a fingerprint scanner, and the corresponding bio signature (102) is a fingerprint.

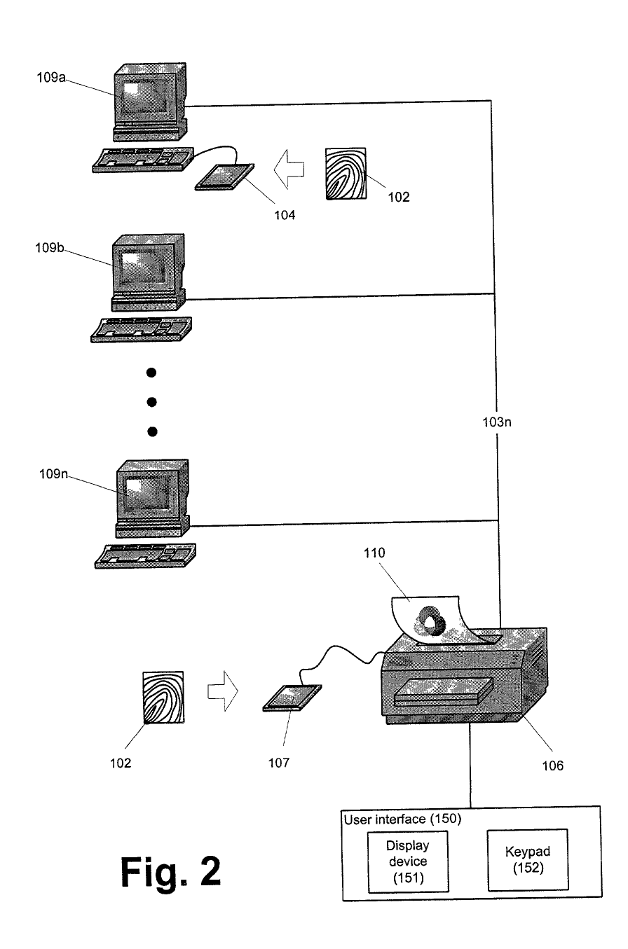

FIG. 2 illustrates an embodiment of the system of the present invention which is implemented in a computer network (103n). In the example of FIG. 2, the printer (106) is a shared resource connected to a network (103n) and accessible to a number of networked host computers (109a-109n). Similarly, any number of printers which require input of a matching bio signature to release secure print jobs could be added to the network illustrated in FIG. 2.

As before, a secured print job can be generated using any of the networked host computers (109a-109n) and sent to the printer (106). While not so illustrated, a biometric identification device (104) may be provided with each host computer (109a-109n).

Alternatively, there may be only one or several biometric identification devices (104) connected to the network (103n). In such an embodiment, each user of the network would need to go to a biometric identification device (104) and input a bio signature that would then be stored on the user's designated host (e.g., 109b) or on the network (103n), e.g., on a shared server (not shown) or designated host (e.g., 109a).

If a library of user bio signatures is stored on the network, that library may be accessible to all networked users. Each bio signature may be indexed by the name of the user whose signature it is or by some other identifier such as an identification number.

When a user wishes to produce a secured print job that can be received by someone else, the user can input an identifier of the authorized recipient(s). The system of the present invention will then access the library of stored bio signatures and associate or incorporate the bio signatures of the designated authorized recipient(s) with the print job. At the printer, if a bio signature is input matching any of the bio signatures associated with the secured print job, the job will be executed and a hardcopy product produced.

Additionally, if there are two or more authorized bio signatures associated with the print job, the printer (106) may track each bio signature that is input and print the job once for each authorized bio signature. In other words, if authorized bio signatures A, B & C are associated with the print job, the printer may print the job three times; once when a bio signature matching signature A is input to the printer, once when a bio signature matching signature B is input to the printer and once again when a bio signature matching signature C is input to the printer.

As an alternative to a network library of bio signatures, each user on the network may be the custodian of his or her own bio signature or may generate a bio signature only when needed. Each person can then transmit his or her bio signature, for example, as an e-mail attachment, to another person on the network who will associate it with a secured print job that is to be accessible to the person providing his or her bio signature.

Also as shown in FIG. 2, the printer (106) of the present invention may have is a user interface (150). The user interface (150) may be in addition to the biometric identification device (107) and may include, for example, a display device (151) and keypad (152) or other device for accepting user input. The user interface (150) may be used to assist the user in operating the printer (106). For example, the printer (106) may display a message on the display device (151) prompting the user to input a bio signature with the biometric identification device when a bio signature is required to release a pending print job. If more than one secured print job is pending on the printer (106) at the same time, the user may use the interface (150) to access a menu or listing of the pending secured print jobs and select the job the user wishes to print.

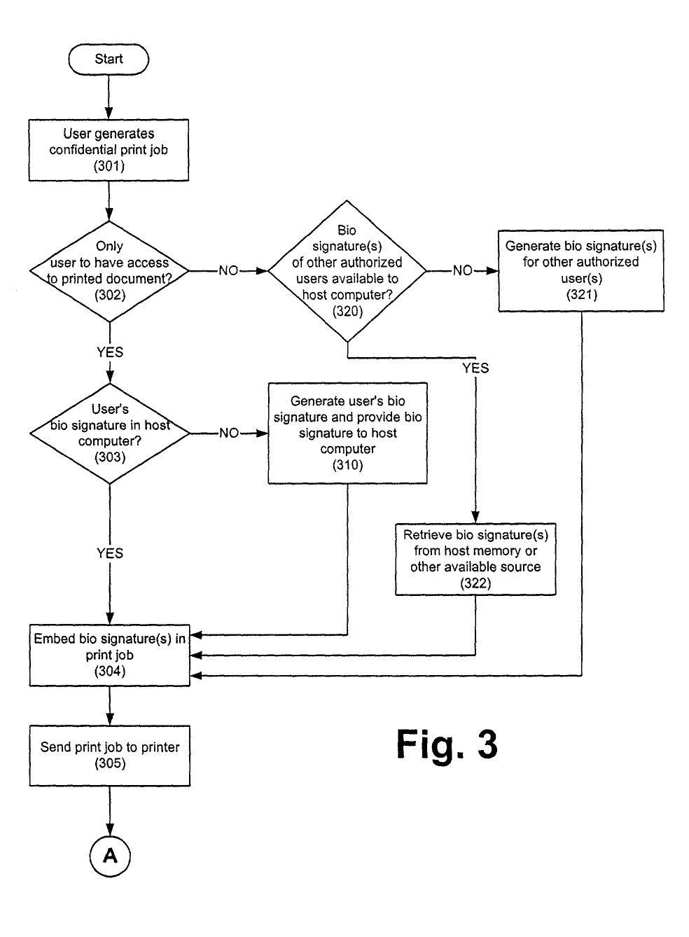

FIG. 3 is a flowchart illustrating a preferred method of generating a secured print job according to the present invention. As shown in FIG. 3, the user first generates a print job that he or she wishes to keep confidential (301). This confidential print job may be a document that only the owner should have access to, or a document that the owner wishes to share with one or more designated recipients (302). If the document is for use by its owner only, the user will attach his or her bio signature to the print job.

If the user's bio signature is already stored on or available to the host computer generating the print job (303), that bio signature can be embedded in or attached to the confidential print job (304). If the user's bio signature is not available, the user may generate a bio signature (310) and then associate that signature with the confidential print job (304). Once the bio signature of the user has been associated with the print job, the secured print job is sent to the printer (305).

If the secured print job is to be available to one or more designated recipients other than, or in addition to, the print job's creator (302), the bio signatures of the designated recipient(s) must be obtained. The user may first check to see if bio signatures for the desired recipient(s) are available to the user's computer (320). For example, the recipient(s) signature(s) may be in a network library of bio signatures. If the recipient(s) bio signature(s) are available, they may be retrieved (322) and attached to the confidential print job (304). If not available, the bio signature(s) of the designated recipient(s) can be generated and transmitted to the print job creator (321) for inclusion in the confidential print job (304). The completed print job is then sent to the printer (305).

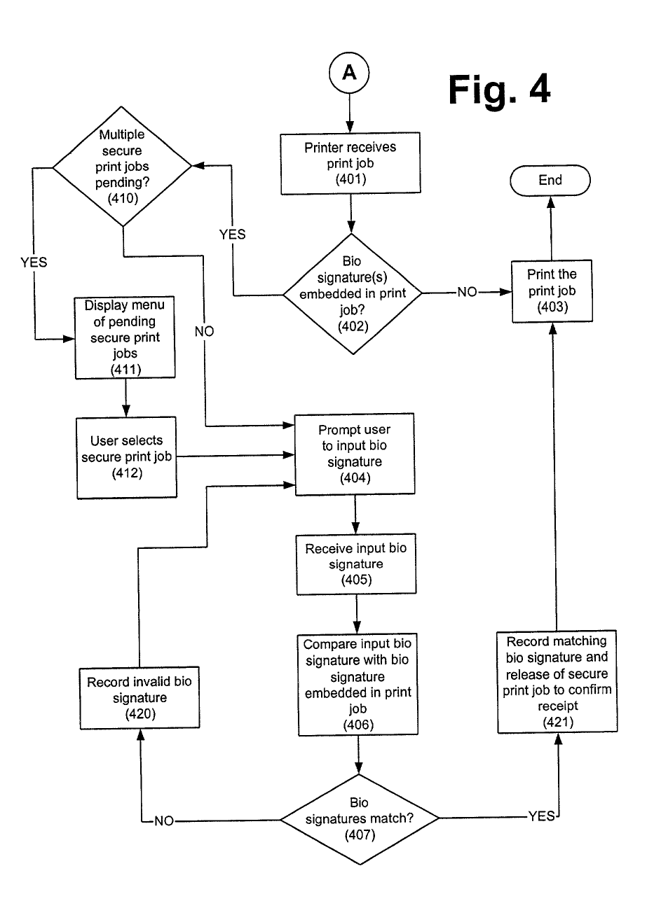

FIG. 4 illustrates a preferred method of operating a printer to print a secured print job according to the principles of the present invention. As shown in FIG. 4, the printer receives the secured print job from a connected host computer or from a fax machine (401). The printer will first ascertain if there are any bio signatures associated with or embedded in the print job (402). If not, the print job will simply be printed as soon as the printer is available, i.e., not outputting a previous print job.

If one or more bio signatures are included in the print job, the printer will next determine if there are multiple secured print jobs pending (410). If not, the printer may prompt the user to enter a bio signature releasing the secured print job (404). This prompt is preferably a message displayed on a display device of the printer's user interface.

If more than one secured print job is pending at the printer, the printer will create a menu of the pending jobs. The secured print jobs may be listed by any means of identifying the various jobs, e.g., by the name of the user originating the print job, by a document number or identifier, by the name of a designated recipient, by a print job name, etc. This menu is displayed on the display device of the printer's user interface (411). A user can then select the secured print job he or she wishes to print (412). The printer may then prompt the user to enter a bio signature releasing the selected print job (404). This prompt is preferably a message displayed on a display device of the printer's user interface.

In response to the prompt to enter a bio signature, the user accordingly enters a bio signature with the biometric identification device at the printer (405). The printer then compares the input bio signature with the bio signature(s) that accompanied the secured print job. (406). If the input bio signature matches any bio signature associated with the secured print job (407), the secured print job is released and output by the printer in hardcopy form (403). Optionally, the system may create a record of the matching bio signature and the release of secure print job (421). This record can be used to confirm receipt of the print job by the authorized recipient. If the bio signatures do not match, the secured print job is not released and will not be printed. The user may be prompted to try re-entering his or her bio signature. Optionally, the system may also make a record of the invalid bio signature entered in an attempt to release the print job (420). This record may be used to identify a person attempting to release a print job without authorization.

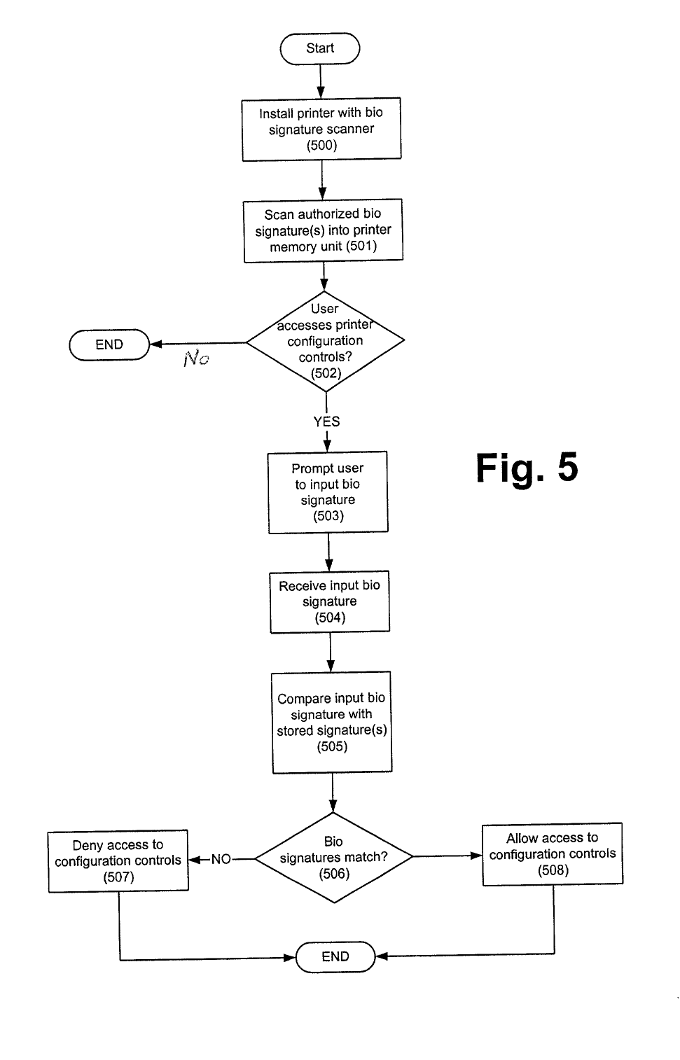

FIG. 5 is a flowchart illustrating another application of the principles of the present invention. As shown in FIG. 5, the principles of the present invention can be applied to securing control of a printer's configuration controls.

First, the printer is installed (500), i.e., connected to the host computer or computer network and configured to operate optimally with that host or network. During the installation process, an authorized administrator will enter a bio signature using the biometric identification device associated with the printer being installed (501). This bio signature will be stored in a static memory device of the printer.

When a user next attempts to access the configuration controls or other settings on the printer (502), the printer will prompt that user to enter a bio signature (503). The user's bio signature is then received (504) and compared to the authorized bio signature(s) stored in static memory (505). If the signatures match (506), the user will be granted access to the configuration or other secured controls of the printer (508). Otherwise, access to the printer controls will be denied (507). In this way, the present invention can be used to prevent the unauthorized and unwanted reconfiguration or control of the printer by someone other than the authorized system administrator(s).

Finally, the principles of the present invention can also be used to track the usage of a printer. For example, the printer may track the number of secured print jobs which are released and printed based on presentation of a particular bio signature. This information can be stored in the printer's static memory unit and retrieved to determine the amount of usage the printer receives from the user whose bio signature has been tracked.

This application of the present invention can be implemented with a photocopy machine which does not receive a print job from a host computer, but rather outputs hardcopies of an original document that is scanned and duplicated. The user may be required to input his or her bio signature using a biometric identification device connected to or integrated in that photocopier in order to activate the photocopier. The copies subsequently made are then allocated or charged to the user whose bio signature was used to activate the photocopier. In this way, usage of the photocopier by authorized users can be readily and accurately tracked.

The present invention also encompasses the computer-readable instructions or software required to cause printers and host computers to function in the manner described herein. And, the flowcharts provided may be considered as outlining that software. As used herein, the term “computer-readable instructions” means software irrespective of the language in which it is written or the level at which written (e.g., source code, object code, etc.). The term “computer-readable instructions” also encompasses firmware, application specific integrated circuits (ASICs) and any other logic device used to control the functionality of the printers and host computers described herein.

For example, the present invention encompasses printer driver software on host computers that allows a user to input a bio signature using a biometric identification device and associate that signature with a print job. The present invention also encompasses software residing in a printer that causes the printer to refuse to print a secured print job until a bio signature is input to the printer matching a bio signature transmitted to the printer with the print job.

The preceding description has been presented only to illustrate and describe the invention. It is not intended to be exhaustive or to limit the invention to any precise form disclosed. Many modifications and variations are possible in light of the above teaching.

The preferred embodiment was chosen and described in order to best explain the principles of the invention and its practical application. The preceding description is intended to enable others skilled in the art to best utilize the invention in various embodiments and with various modifications as are suited to the particular use contemplated. It is intended that the scope of the invention be defined by the following claims.

What is claimed is:

1. A system for printing a secured print job that has one or more bio signatures associated therewith, the system comprising:
a printer for outputting print jobs in hardcopy form; and
a biometric identification device associated with said printer for inputting bio signatures to said printer,
wherein said printer will not print said secured print job unless a bio signature is entered with said biometric identification device that matches a bio signature associated with said secured print job.

2. The system of claim 1, further comprising a host computer for generating said secured print job, said host computer associating said one or more bio signatures with said print job and transmitting said print job to said printer.

3. The system of claim 2, further comprising a second biometric identification device associated with said host computer for generating said bio signature associated with said secured print job.

4. The system of claim 1, wherein said printer is a fax machine.

5. The system of claim 1, wherein said bio signature is an electronic representation of a user's fingerprint.

6. The system of claim 1, wherein said printer further comprises:
a display device for listing pending secured print jobs; and
a user input device for selecting a secured print job to output.

7. The system of claim 2, wherein:
said host computer and said printer are connected via a computer network; and
said one or more bio signatures associated with said secured print job are retrieved by said host computer from said computer network.

8. The system of claim 1, wherein said printer denies access to configuration controls of said printer unless an authorized bio signature matching a bio signature stored in said computer is input using said biometric identification device.

9. The system of claim 1, wherein said printer tracks usage of said printer using bio signatures input with said biometric identification device.

10. A printer for printing a secured print job that has one or more bio signatures associated therewith, the printer comprising:
a printing mechanism for outputting print jobs in hardcopy form; and
a biometric identification device associated with said printer for inputting bio signatures to said printer,
wherein said printing mechanism will not print said secured print job unless a bio signature is entered with said biometric identification device that matches a bio signatures associated with said secured print job.

11. A method of printing a secured print job that has one or more bio signatures associated therewith, the method comprising printing said secured print job with a printer only when a bio signature is entered into said printer with a biometric identification device associated with said printer that matches said a bio signature associated with said secured print job.

12. The method of claim 11, further comprising generating said secured print job by associating said one or more bio signatures with said print job and transmitting said print job to said printer.

13. The method of claim 11, wherein said bio signature is an electronic representation of a user's fingerprint.

14. The method of claim 11, further comprising:
listing pending secured print jobs on a display device of said printer; and
selecting a secured print job to output from said listing.

15. The method of claim 12, wherein said generating of said secured print job is performed with a host computer connected to a computer network; said method further comprising retrieving said one or more bio signatures associated with said secured print job from said computer network.

16. The method of claim 11, further comprising denying access to configuration controls of said printer unless an authorized bio signature matching a bio signature stored in said computer is input using said biometric identification device.

17. The method of claim 11, further comprising tracking usage of said printer using bio signatures input with said biometric identification device.

18. Computer-readable instructions stored on a medium for storing computer readable instructions, said instructions causing a printer to print a secured print job only when a bio signature is entered into said printer with a biometric identification device associated with said printer that matches said a bio signature associated with said secured print job.

19. The computer-readable instructions of claim 18, wherein said instructions are partially incorporated in a printer driver of a host computer and cause said host computer to generate said secured print job by associating said one or more bio signatures with said print job and transmitting said print job to said printer.

20. The computer-readable instructions of claim 18, wherein said instructions further cause said printer to:
list pending secured print jobs on a display device of said printer; and
accept a user selection of a secured print job from said listing.
